(19) United States
(12) Patent Application Publication
(10) Pub. No.: US 2004/0267549 A1
(43) Pub. Date: Dec. 30, 2004

(54) Methods and systems for assisting in real estate transactions with automation utilizing verbal communication

(75) Inventors: Dave Anderson, Lawrenceville, GA (US); Senis Busayapongchai, Tucker, GA (US)

Correspondence Address: BELLSOUTH CORPORATION, P.O. BOX 2903, MINNEAPOLIS, MN, 55402-0903, US

(73) Assignee: BellSouth Intellectual Property Corporation

(21) Appl. No.: 10/603,403

(22) Filed: Jun. 24, 2003

(51) Int. Cl. G06F 17/60

(52) U.S. Cl. 705/1

(57) ABSTRACT

Methods and systems assist in real estate transactions by automating the generation of real estate listings utilizing verbal communication with a real estate seller and/or automating the access of real estate listings utilizing verbal communication with real estate customers. A real estate seller may contact a listing service by telephone to provide verbal answers to questions posed through a voice services node. The verbal answers are converted to listing data that is stored for later retrieval when needed by a real estate customer. A real estate customer may contact a listing service by a voice call to provide verbal information that identifies a piece of real estate of interest or identifies real estate preferences. A voice services node then verbally provides listing information about the piece of real estate or about pieces of real estate matching the preferences to the real estate customer.

### TECHNICAL FIELD

The present invention is related to real estate listings posted by real estate sellers and relied upon by real estate customers. More particularly, the present invention is related to assisting in real estate transactions by automating the posting and/or accessing of real estate listings while utilizing verbal communication with the posting and/or accessing of the listings.

### BACKGROUND

Real estate transactions are typically brought about by real estate sellers creating real estate listings that provide details about various pieces of real estate that are up for sale or rent. These listings may be within a multiple listing service (“MLS”) that real estate sellers may access when looking for real estate for customers. The listings may be provided on web sites that real estate customers may directly access. Also, the listings may be provided on fliers located in front of the piece of real estate of interest. This later promotion may be used by both real estate agents and property owners selling independently. Both real estate agents and property owners selling independently will be referred to herein as real estate sellers.

Real estate customers utilize these listings when shopping for real estate. However, these customers, especially home buyers, often drive around neighborhoods or other locations of interest to see what real estate is on the market. When a piece of real estate of interest is found, the customer often wants to find out as much information as possible about the piece of real estate. At that time, the real estate seller may not be available, and there may be no other source of information available to the customer because no fliers have been provided or none remain. Further, the customer may have questions that any available flyer fails to address. Also, the real estate customer may wish to know what pieces of real estate within a general location are available but again has no way at that time to make such a determination other than to continue driving around until hopefully finding each piece of real estate that is available.

Thus, real estate customers are often forced to wait until some later time to determine the desired information about a piece of real estate of interest and/or to determine all of the real estate within a particular area that is available. This may be troublesome to the real estate customer and may also result in the customer losing interest in a particular piece of real estate or a general location. As a result, real estate sellers may not complete transactions as quickly as desired.

One technique used to aid customers in getting information about a piece of real estate at the time the customer is at that location is to provide an automated audio information function for the sign posted on the property. Such an audio information function provides a structured recording that allows no interaction with the customer. The customer may be required to listen to a lengthy recording, and information of interest is not easily repeated as the whole recording usually must be repeated instead. Furthermore, additional drawbacks of this approach are that these recordings generally require the hiring of voice talent and that scripts be prepared.

### SUMMARY

Embodiments of the present invention address these issues and others by automating the posting or accessing of listing information while providing for verbal communication with the real estate seller or customer over a voiced call. Thus, the seller can make a listing available by verbally communicating information about the listing over a voiced call to a voice services node linked to a listing service. Likewise, a customer can access a listing in real time by verbally communicating information about the listing over a voiced call to a voice services node.

One embodiment is a method of assisting real estate sales with automation utilizing verbal communication. The method involves providing question data to a voice services node and providing a set of verbal questions about a real estate listing corresponding to the question data from a voice services node over a voiced call with a real estate seller. Verbal answers to the set of verbal questions are received from the real estate seller at the voice services node. The received verbal answers are interpreted to produce listing data, and the listing data is posted for access by real estate customers.

Another embodiment is a method of assisting real estate purchases with automation utilizing verbal communication. The method involves receiving verbal information from a real estate customer at a voice services node. The verbal information is interpreted to produce a query for real estate listing data. The real estate listing data resulting from the query is converted into verbal real estate listing information, and the verbal real estate listing information is provided from the voice services node to the real estate customer.

Another embodiment is a system for assisting real estate sales with automation utilizing verbal communication. The system includes a voice services node that provides verbal questions based on question data to a real estate seller, receives verbal answers from the real estate seller, and interprets the verbal answers to produce answer data. The system also includes a listing database containing listing data. A network-based computer-implemented application provides the question data to the voice services node, receives the answer data from the voice services node, and stores the answer data as listing data in the database where it is accessible for real estate customers.

Another embodiment is a system for assisting real estate purchases with automation utilizing verbal communication. The system includes a voice services node that receives verbal information from a real estate customer, interprets the verbal information to produce query data, and provides verbal responses to the real estate customer based on listing data. The system also includes a listing database containing listing data. A network-based computer-implemented application receives query data from the voice services node to produce a query of listing data and provides listing data resulting from the query to the voice services node.

### DESCRIPTION OF THE DRAWINGS

FIG. 1 shows one illustrative embodiment of a system for assisting real estate sellers and/or customers in posting or accessing listing information where verbal communication occurs with the seller or customer.

FIG. 2 illustrates one set of logical operations that may be performed within the system of FIG. 1 to automate the posting of listing information by a seller.

FIGS. 3 and 4 illustrate a second set of logical operations that may be performed within the system of FIG. 1 to automate the accessing of the listing information by a customer.

### DETAILED DESCRIPTION

Embodiments of the present invention provide real estate sellers and customers with a network-based automated service that handles listing and/or accessing of real estate information. The real estate listing information may be provided from the real estate seller through verbal communication with the automated system or from other sources. The real estate listing information may be accessed by the real estate customer through verbal communication with the automated system.

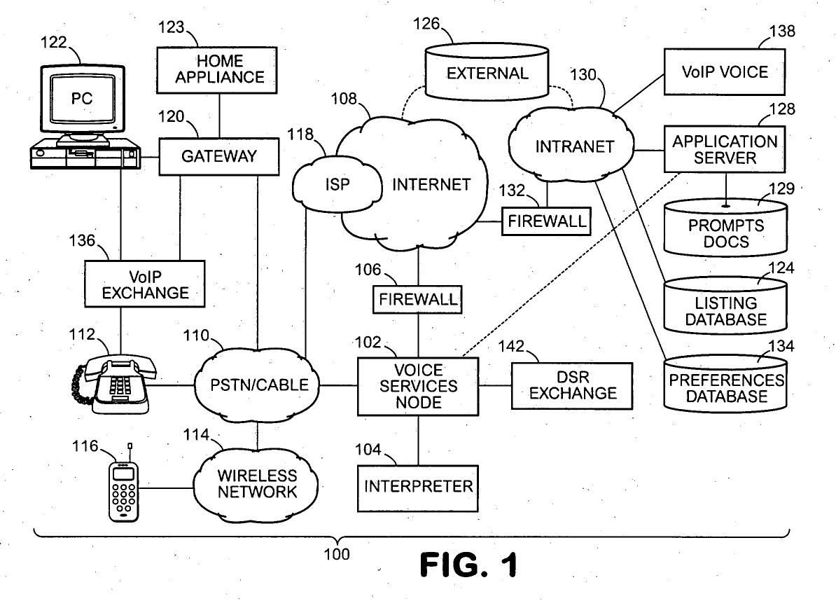

FIG. 1 illustrates one example of an encompassing communications network 100 interconnecting verbal communications devices of the real estate seller and/or customer with the network-based system that automates the posting and accessing of real estate listing information. The seller and/or customer may access the system through several different channels of verbal communication. As discussed below, the customer communicates verbally with a voice services node that may be present in various locations for different embodiments.

As one example, the seller or customer may place a conventional voiced call from a telephone 112 through a network 110 such as a public switched telephone network (“PSTN”) or adapted cable television network. The call terminates at a terminating voice services node 102 of the PSTN/cable network 110 according to the number dialed by the seller or customer. This voice services node 102 is a common terminating point within an advanced intelligent network (“AIN”) of modern PSTNs or adapted cable networks and is typically implemented as a soft switch and media server combination.

Another example of accessing the system is by the seller or customer placing a voiced call from a wireless phone 116. The wireless phone 116 maintains a wireless connection to a wireless network 114 that includes base stations and switching centers as well as a gateway to the PSTN/cable network 110. The PSTN/cable network 110 then directs the call from the wireless phone 116 to the voice services node 102 according to the number dialed by the seller or customer on the wireless phone 116. Furthermore, the wireless phone 116 may function as a thin client device relative to the verbal functions of the automated listing service such that the wireless phone 116 implements a distributed speech recognition (“DSR”) platform to minimize the information transmitted through the wireless connection. The DSR platform takes the verbal communication received from the customer at the wireless device 116 and generates parameterization data from the verbal communication. The DSR platform then transmits the parameterization data as the verbal communication to the voice service node 102 or 138 rather than all the data representing the verbal communications. The voice services node 102 or 138 then utilizes a DSR exchange function 142 to translate the DSR parameterization data into representative text which the voice services node 102 or 138 can deliver to an application server 128.

Another example of accessing the system is by the seller or customer placing a voiced call from a voice-over-IP (“VoIP”) based device such as a personal computer 122 or where telephone 112 is a VoIP phone. This VoIP call from the seller or customer may be to a local VoIP exchange 136 which converts the VoIP communications from the device of the seller or customer into conventional telephone signals that are passed to the PSTN 110 and on to the voice services node 102. The VoIP exchange 136 converts the conventional telephone signals from the PSTN 110 to VoIP packet data that is then distributed to the telephone 112 or computer 122 where it becomes verbal information to the seller or customer. Furthermore, the wireless phone 116 may be VoIP capable such that VoIP communication occurs with the wireless data network 114 and is converted to speech prior to delivery to the voice services node 102.

The VoIP call from the seller or customer may alternatively be through an Internet gateway 120 of the seller or customer, such as a broadband connection or wireless data network 114, to an Internet Service Provider (“ISP”) 118. The ISP 118 interconnects the gateway 120 of the seller or customer or wireless data network 114 to the Internet 108 which then directs the VoIP call according to the number dialed, which signifies an Internet address of a voice services node 138 of an intranet 130 from which the real estate listing service is provided. This intranet 130 is typically protected from the Internet 108 by a firewall 132. The voice service node 138 includes a VoIP interface and is typically implemented as a media gateway and server which performs the VoIP-voice conversion such as that performed by the VoIP exchange 136 and also performs text-to-speech and speech recognition such as that performed by the voice services node 102 and discussed below. Accordingly, the discussion of the functions of the voice services node 102 also applies to the functions of the voice service node 138.

As yet another example, the wireless device 116 may be a wireless data device such as a personal digital assistant. The wireless device 116 and/or personal computer 122 may have a wi-fi wireless data connection such as IEEE 802.11 to the gateway 120 or directly to the wireless network 114 such that the verbal communication received from the customer is encoded in data communications between the wi-fi device of the customer and the gateway 120 or wireless network 114.

Another example of accessing a voice services node 102 or 138 is through verbal interaction with an interactive home appliance 123. Such interactive home appliances may maintain connections to a local network of the customer as provided through a gateway 120 and may have access to outbound networks, including the PSTN/cable network 110 and/or the Internet 108. Thus, the verbal communication may be received at the home appliance 123 and then channeled via VoIP through the Internet 108 to the voice services node 138 or may be channeled via the PSTN/cable network 110 to the voice services node 102.

Yet another example provides for the voice services node to be implemented in the gateway 120 or other local device of the customer so that the voice call with the customer is directly connected with the voice services node within the customer's local network rather than passing through the Internet 108 or PSTN/cable network 110. The data created by the voice services node from the verbal communication from the customer is then passed through the communications network 100, such as via a broadband connection through the PSTN/cable 110 and to the ISP 118 and Internet 108 and then on to the application server 128. Likewise, the data representing the verbal communication to be provided to the customer is provided over the communications network 100 back to the voice services node within the customer's local network where it is then converted into verbal communication provided to the customer.

The voice services node 102 provides text-to-speech conversions or appropriate pre-recordings to provide verbal communication to the seller or customer over the voiced call and performs speech recognition and natural language understanding to receive verbal communication from the seller or customer. Accordingly, the seller or customer may carry on a natural language conversation with the voice services node 102. To perform these conversations, the voice services node 102 implements a platform such as the well-known voice extensible markup language (“VoiceXML”) context which utilizes a VoiceXML interpreter 104 in conjunction with VoiceXML documents. Another well-known platform employs speech application language tags (“SALT”). The interpreter 104 operates upon the VoiceXML or SALT documents to produce verbal communication of a conversation. The VoiceXML or SALT document provides the content to be spoken from the voice services node 102. The VoiceXML or SALT document is received by the VoiceXML or SALT interpreter 104 through a data network connection of the communications network 100 in response to a voiced call being established with the seller or customer at the voice services node 102. This data network connection as shown in the illustrative system of FIG. 1 includes a link through a firewall 106 to the Internet 108 and on through the firewall 132 to the intranet 130.

The verbal communication from the seller or customer is received at the, voice services node 102 and is converted into data representing the spoken words and their meanings through a conventional speech recognition and natural language understanding function of the voice services node 102. The VoiceXML or SALT document that the VoiceXML or SALT interpreter 104 is operating upon sets forth a timing of when verbal information that has been received and converted to data is packaged in a particular request back to the VoiceXML or SALT document application server over the data network. This timing provided by the VoiceXML or SALT document allows the verbal responses of the seller or customer to be matched with the verbal questions and responses of the VoiceXML or SALT document. Matching the communication of the seller or customer to the communication from the voice services node enables an application server 128 of the intranet 130 to properly act upon the verbal communication from the seller or customer. As shown, the application server 128 may interact with a voice services node through an intranet 130, through the Internet 108, or through a more direct network data connection as indicated by the dashed line.

The application server 128 is a conventional computer server that implements an application program to control the automated listing service for the seller or customer. The application server 128 provides the VoiceXML or SALT documents to the voice services node 102 to bring about the conversation with the seller or customer over the voiced call through the PSTN 110 and/or to the voice services node 138 to bring about the conversation with the seller or customer over the VoIP Internet call. The application server 128 may additionally or alternatively provide files of pre-recorded verbal prompts to the voice services node where the file is implemented to produce verbal communication. The application server 128 may store the various pre-recorded prompts, grammars, and VoiceXML or SALT documents in a database 129. The application server also interacts with a customer profile database 134 that stores profile information for each customer, such as the particular preferences of the customer for various purchases and/or past requests to the automated listing service.

In addition to providing VoiceXML or SALT documents to the one or more voice services nodes of the communications network 100, the application server 128 may also serve hyper-text markup language (“HTML”), wireless application protocol (“WAP”), or other distributed document formats depending upon the manner in which the application server has been accessed. For example, a seller or customer may choose to send the application server information by accessing a web page provided by the application server to the personal computer 122 through HTML or to the wireless device 116 through WAP via a data connection between the wireless network 114 and the ISP 118. Such HTML or WAP pages may provide a template for entering information where the template asks a question and provides an entry field for the seller or customer to enter the answer. Answers from sellers for listings that are being posted are stored in a listing database 124 while preferences of customers searching for real estate listings is stored in a preferences database 134.

Additionally, the application server 128 may provide visual data such as maps, photographs, and other displays for a listing that are relevant to real estate sellers and customers. Accordingly, where the device being used by the individual contacting the service supports visual displays, such visual data may be displayed for the individual in addition to the verbal information being provided to describe the listing.

The application server 128 interacts with the listing database 124 which contains the listing information that is provided verbally by the seller over a voiced call and that is provided verbally to the customer over a voiced call. The listing database 124 typically groups detailed information for each real estate listing. For example, each listing has several categories of information that can be individually accessed as desired by the customer such as asking price, number of bedrooms and bathrooms, exterior construction, year built, etc.

When the real estate seller provides the verbal information, the information is stored by the application server 128 in the proper category for a listing in the listing database 124. For example, the real estate seller may say that “the asking price is $150,000.” The application server 128 recognizes the phrase “asking price” and recognizes the numerical amount. The application server 128 then stores the numerical amount for the price category in the listing database 124.

Likewise, the customer may verbally instruct to search the listings for a house that costs $150,000. The application server 128 recognizes the phrase “house that costs” and its association to the price category of the listing database 124. The application server 128 also recognizes the numerical amount of “$150,000” and searches for this value in the price category to return matching house listings or near matches to the customer verbally. It is also possible for the customer to request information on a specific house or property and then listen to the listing information for that specific house that is provided verbally from the automated listing service. The customer can listen to the verbal information or interrupt and request information about specific interests such as the type of floor in the kitchen. This verbal interaction is discussed in more detail below.

In addition to the listing database 124, the preferences database 134 contains the preference information that has been provided by the customer or has been obtained in other manners discussed above. The application server 128 provides the relevant profile data for a particular search when a search of real estate listings is to be performed for the customer. The preferences database 134 may contain many categories of information for a customer. For example, the preferences database 134 may contain listing preferences such as the permissible exterior constructions, neighborhoods, and the number of bedrooms and bathrooms. Additionally, the customer preferences may specify the range of acceptable prices for a listing.

As shown in FIG. 1, the preferences database 134 may reside on the intranet 130 for the network-based listing service. However, the preferences database 134 likely contains information that the customer considers to he sensitive, such as the acceptable price range of listings. Accordingly, an alternative is to provide customer preferences database storage at the customer's residence or place of business so that the customer feels that the profile data is more secure and is within the control of the customer. In this case, the application server 128 maintains an address of the customer preferences database storage maintained by the customer rather than maintaining an address of the customer preferences database 134 of the intranet 130 so that it can access the preferences data as necessary.

In addition to the preferences database 134 and listing database 124, the application server 128 may interact with an external listing database 126, such as the multiple listing service (“MLS”) database, through the intranet 130 and/or Internet 108. The MLS database is a listing service available to real estate sellers that allows them to place photograph and text-based categorized listings via services such as Flat Rate Realty USA. The real estate seller may instruct the automated service to populate a listing in the listing database 124 with information already present in the MLS database 126. Alternatively, the application server 128 may access data directly from the MLS database 126 when providing listing information to a customer.

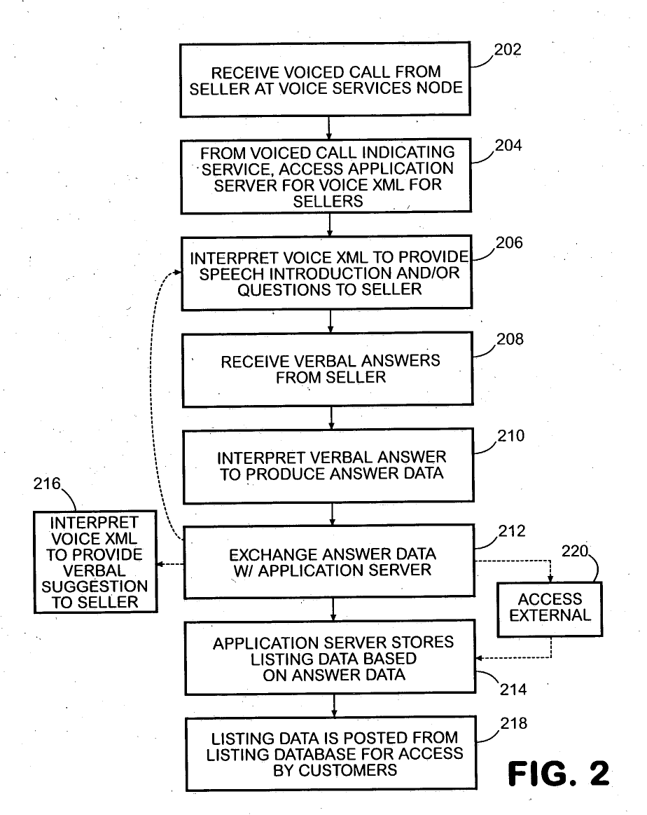

FIG. 2 illustrates one example of logical operations that may be performed within the communications network 100 of FIG. 1 to allow a real estate seller to verbally place listing data in the listing database for subsequent access by customers. This set of logical operations is provided for purposes of illustration and is not intended to be limiting. For example, these logical operations discuss the application of VoiceXML within the communications network 100. However, it will be appreciated that alternative platforms for distributed verbal output, such as text-to-speech or pre-recorded speech, and speech recognition may be used in place of VoiceXML, such as the SALT platform discussed above, or a proprietary less open method.

The logical operations of FIG. 2 begin at call operation 202 where the seller places a voiced call to a voice services node such as by dialing the number for the listing service for the voice services node on the communications network or by selecting an icon on the personal computer where the voiced call is placed through the computer. At access operation 204, the voice services node accesses the appropriate application server according to the voice call (i.e., according to the number dialed, icon selected, or other indicator provided by the customer). Utilizing the dialed number or other indicator of the voice call to distinguish one application server from another allows a single voice services node to accommodate multiple verbal communication services simultaneously. The voice services node may provide identification data to the application server for the seller based on the received caller ID information for the seller which allows the application server to access any existing listings associated with the seller or to create an association to the seller for a new listing that the seller will create.

Alternatively, the voice services node may implement a standard VoiceXML introduction page to inform the seller that he has dialed into the service and ask that the seller say his formal name or other form of identification, such as a user name and password. This identification can then be captured as data and provided back to the application server where it is utilized to access the listings for the seller. In addition, the given user identification can be verified using a voice verification technique.

Once the voice services node receives the VoiceXML, it is interpreted at speech operation 206 to convert the VoiceXML text or pre-recorded voice files to speech that is verbally provided to the seller. This verbal information may provide further introduction and guidance to the seller about using the system. This guidance may inform the seller that the seller can barge in at any time with a question or with an instruction. The guidance may also specifically ask that the seller provide a verbal command, such as a new listing request or a request to update an existing listing and/or provide an answer to a particular listing question such as how many bathrooms for a new listing.

Eventually, the voice services node receives a verbal listing request or answer to a previously provided listing question from the seller at request operation 208. This verbal request or answer may be detailed so that it provides many details of the new listing or listing update. For example, the seller may request a new listing and provide a verbal answer that specifies information for all the required categories of the listing. This request may also be more general, such as specifying that a new listing should be added but not providing any details. As discussed below, the automated system may then conduct a series of question and answer repetitions to obtain the necessary detail for the listing from the seller.

The verbal request from the seller is interpreted at the voice services node to produce instruction data that represents the words spoken by the seller at recognition operation 210. This data is representative of the words spoken by the individual that are obtained within a window of time provided by the VoiceXML document for receiving verbal requests so that the application server can determine from keywords of the instruction data what the seller wants the service to do. The instruction data is transferred from the voice services node over the data network to the application server at exchange operation 212.

Upon receiving the instruction data, the application server then determines the next appropriate action by interpreting whether the answer data requires follow-up questions to the seller to obtain additional data for the listing at data operation 216. Upon determining that more information is necessary, the application server formulates question data which is provided back to the voice services node through exchange Operation 212. For example, if the seller did not provide information about a basement, then the application server may provide a question about a basement. Further, if the seller stated that there is a basement but did not specify whether it was finished, the application server may provide a question about whether the basement is finished.

There may be several levels of detail that the application server may continue to question and upon receiving the answers, the application server may then formulate a suggestion to the seller at data operation 216 and exchange with the voice services node through exchange operation 212. For example, if the application server has asked about a basement, then whether it is finished, and then whether it has a bathroom, the seller may have responded that there is a basement, it is finished, and it has one full bathroom. The application server then provides a suggestion such as, “for future listings, you may state that the house has a finished basement that includes one full bathroom.” Thus, the seller may learn how to more efficiently interact with the automated service by taking note of such suggestions.

When the application server makes a determination that a new question should be provided to the seller, the operational flow returns to speech operation 206. As discussed above, at this operation the voice services node interprets the VoiceXML question data from the application server to provide a verbal question back to the seller over the voiced call. When the application server makes a determination that answer data that has been provided is adequate to store within a category of a listing, then the application server stores the data within the listing database at database operation 214. When the application server makes a determination that the seller has requested that data from a particular MLS listing be used including providing an identifier of the MLS listing such as the MLS number, the application server accesses the MLS listing at MLS operation 220 and then stores the listing data at database operation 214.

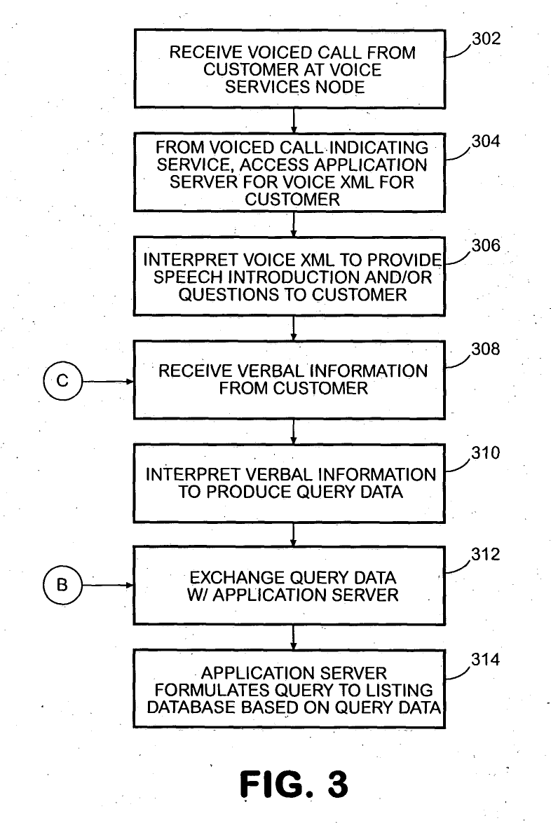

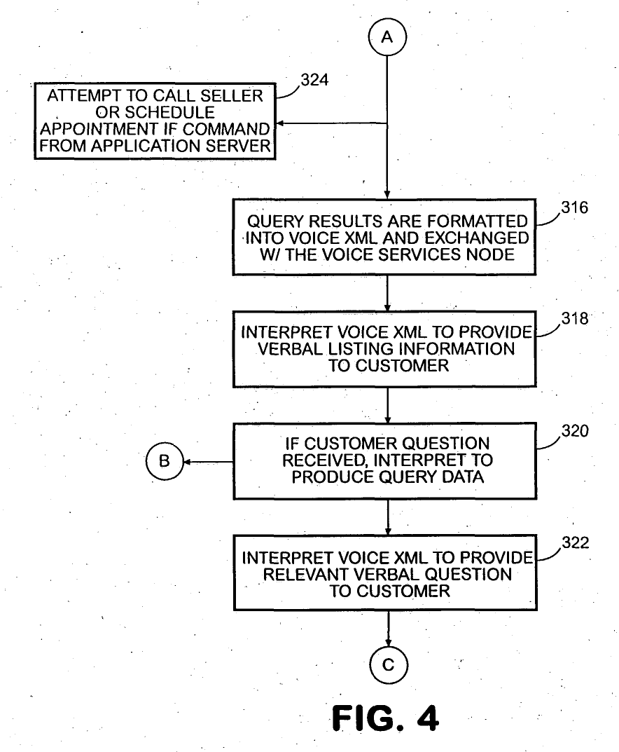

Upon storing a complete set of listing data within the listing database for a particular real estate listing, the application server then posts the listing data from the database to make it available for access by a real estate customer at access operation 218. The listing data may be posted for access by real estate customers in various ways. For example, the listing database may be made accessible through a web page that can be accessed by the customer through a personal computer linked to the Internet. The listing database may also be made accessible through verbal communications with the customer. The details of how the real estate customer accesses the listing data posted from the listing database verbally over the communications network is described below with reference to FIGS. 3 and 4.

FIGS. 3 and 4 illustrate one example of logical operations that may be performed within the communications network 100 of FIG. 1 to allow a real estate customer to verbally access listing data of the listing database that has been previously stored. This set of logical operations is also provided for purposes of illustration and is not intended to be limiting. As with the logical operations of FIG. 2, these logical operations discuss the application of VoiceXML within the communications network 100. However, it will be appreciated that alternative platforms for distributed voice output and speech recognition such as SALT may be used in place of VoiceXML for these logical operations as well.

The logical operations of FIGS. 3 and 4 begin at call operation 302 where the customer places a voiced call to a voice services node such as by dialing the number for the listing service for the voice services node on the communications network or by selecting an icon on the personal computer where the voiced call is placed through the computer. At access operation 304, the voice services node accesses the appropriate application server according to the voice call (i.e., according to the number dialed, icon selected, or other indicator provided by the customer). As discussed above, utilizing the dialed number to distinguish one application server from another allows a single voice services node to accommodate multiple verbal communication services simultaneously. The voice services node may provide identification data to the application server for the customer based on the received caller ID information for the customer which allows the application server to access any existing preferences and listings associated with the customer or to create an association of the customer to a listing. Where the customer is utilizing a wireless phone 116, the latitude and longitude coordinates of the customer may be determined by the wireless network 114 and passed on to the application server 128 so that the customer may be automatically linked to a specific listing or listings matching or nearly matching those coordinates.

Alternatively, the voice services node may implement a standard VoiceXML introduction page to greet the customer (such as for a free service) or inform the customer that he has dialed into the service and ask that the customer say his formal name or other form of identification, such as a user name and password (such as for a subscription service). This identification can then be captured as data and provided back to the application server where it is utilized to access the associated listings and/or preferences for the customer. Again, the given customer identification may be verified using a voice verification technique.

Once the voice services node receives the VoiceXML, it is interpreted at speech operation 306 to convert the VoiceXML text to speech that is then verbally provided to the customer. This verbal information may provide further introduction and guidance to the customer about using the system.: This guidance may inform the customer that the customer can barge in at any time with a question or with an instruction. The guidance may also specifically ask that the customer provide a verbal command, such as a general listing search, a request for a specific property, a request to update preferences, and/or provide an answer to a particular listing question such as how many bathrooms should be included in the search if not already specified.

Eventually, the voice services node receives a verbal listing request or answer to a previously provided listing question from the customer at request operation 308. This verbal request or answer may be detailed so that it provides many details of the search to be performed or the update to the preferences for the customer. For example, the customer may request a general search and provide verbal information that specifies information for all the available categories of the listings to be searched. This request may be very general, such as specifying that a search should be performed for a particular neighborhood but not providing any other details about the house. As discussed below, the automated system may then conduct a series of question and answer repetitions to obtain the necessary detail to narrow the search for the customer. A request for a specific property may include the property address and city or other unique identifier.

The verbal request from the customer is interpreted at the voice services node to produce query data that represents the words spoken by the customer at recognition operation 310. This data is representative of the words spoken by the individual that are obtained within a window of time provided by the VoiceXML document for receiving verbal requests so that the application server can determine from keywords of the query data what the customer wants the service to do. The query data is transferred from the voice services node over the data network to the application server at exchange operation 312.

Upon receiving the query data, the application server then prepares a query to the listing database from the keywords spoken by the customer that are represented within the query data at database operation 314. This query may be based solely upon the query data representing the words spoken by the customer, based upon identifying information captured in the call from the customer, or the query may also utilize any preferences stored for the customer in the preferences database. For example, the preferences database may contain the desired features of a home so that the customer only requests that a search be performed in a particular neighborhood and the query contains the features augmented by the specified neighborhood as specified by the caller. The search then returns those homes within the neighborhood that most closely match the desired features specified by the preferences database.

As opposed to utilizing stored preferences for a search, there may be several levels of detail that the application server may continue to question about by providing question data back to the voice services node where they are provided at speech operation 306. Upon receiving the answers, the application server may then formulate a query to the listing database. Another alternative is that the customer specifies a particular address or other unique identifier, such as when the customer is driving around a neighborhood and comes upon a home. The specified address is utilized by the application server in the query to retrieve this particular listing from the listing database as opposed to performing a search based on desired criteria.

Upon completing the query to the database for a general search based on search criteria or based on a search for a specific listing, the application server then formats the search results into VoiceXML data of a VoiceXML document which is exchanged with the voice services node at exchange operation 316. Also, the application server may initiate contact with the seller associated with a specific listing identified by the customer at contact operation 324. The specific listing may be identified either by the customer requesting a search of a specific address or by the customer selecting the listing from search results upon subsequent iterations of the logical flow. The application server may instruct the voice services node via a VoiceXML document to attempt a call to the seller to verbally schedule an appointment for the customer to view the home, or the application server may attempt to access an electronic calendar of the seller or other predetermined scheduling or notification method that is available over a network connection. For example, a calendar for sellers may be maintained in a separate database on the intranet hosting the application server or may be accessible over the Internet. Likewise, an ipage message may be sent if a voice connection is not possible. The attempted scheduling at contact operation 324 may proceed according to an automated scheduling process, such as through an automated scheduling service described in co-pending U.S. patent application Ser. No. [unknown at this time] entitled METHODS AND SYSTEMS FOR ASSISTING SCHEDULING WITH AUTOMATION.

Upon the voice services node receiving the VoiceXML data resulting from the query to the listing database, the voice services node provides the verbal communication of the search results to the customer at speech operation 318. For example, a summary of one or more listings that have resulted may be spoken to the customer and an option to hear more detailed information such as directions to the piece of real estate and precise details of the house may also be provided. During this time, the voice services node is monitoring for verbal communication from the customer which allows the customer to barge-in to ask the information to be repeated or to ask a question about the listing that the summary has not yet answered or to request that the detailed information be provided. Upon a question from the customer being received, the voice services node interprets the question to produce additional query data at recognition operation 320. Operational flow then returns to exchange operation 312 where the query data is exchanged with the application server so that a query can be formulated based on key words of the query data. For example, the customer may ask about whether the master bedroom is on the main floor and a query is generated to the listing database for a master bedroom category for the listing to return an answer for the customer.

The VoiceXML document received from the application server at the voice services node may specify that a particular question be directed to the customer upon providing the customer with the verbal communication relating to the search of the listing data. The voice services node interprets the VoiceXML data to provide the verbal question at speech operation 322. For example, the customer may be asked if the customer has any more questions about the listing or may ask a specific question such as whether the customer prefers a master on the main floor or on another floor in response to the customer previously asking whether the bedroom was located on the main floor. The VoiceXML data may also specify that the voice services node ask the customer whether the customer would like an appointment to be set up to view the house, corresponding to the scheduling of an appointment at contact operation 324. Upon providing the verbal question at speech operation 322, operational flow then returns to request operation 308 where the voice services node receives the verbal response from the customer and then proceeds to provide query data for the response to the application server.

In addition to the logical operations discussed above in relation to FIGS. 2-4, a context sensitive help option may also be available to the real estate seller or customer. For example, the automated listing service may monitor for a verbal help request from the seller or customer at any point in time and then provide a response to the help request that is pertinent to the current dialogue state. As a specific example, if the customer is requesting that a search be performed and the automated service has requested that the customer specify criteria for the search, the customer may request help at that time and the automated system provides examples of the criteria that the customer may specify to allow the customer to proceed with initiating the automated search process.

Accordingly, an automated system as discussed above with reference to FIGS. 1-4 provides a real estate listing service which enables verbal communication to be exchanged with the real estate seller or customer. The real estate seller can place a voiced call when a new listing should be added to the listing service and then made available to the customer. The customer can place a voiced call to the system to access the listing data when the customer would like more information about homes that are currently available and/or about a particular home that the customer has found to be for sale.

Although the present invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method of assisting real estate sales with automation utilizing verbal communication, comprising:
providing question data to a voice services node;
providing a set of verbal questions about a real estate listing corresponding to the question data from the voice services node over a voiced call with a real estate seller;
receiving verbal answers to the set of verbal questions from the real estate seller at the voice services node;
interpreting the received verbal answers to produce listing data; and
posting the listing data for access by real estate customers.

2. The method of claim 1, wherein providing a set of verbal questions comprises providing a first verbal question and awaiting a verbal answer to be received prior to providing a second verbal question.

3. The method of claim 2, wherein the second verbal question is dependent upon the verbal answer received for the first verbal question.

4. The method of claim 3, further comprising:
after receiving a verbal answer to the second verbal question at the voice services node, generating a suggestion based on the verbal answer to the first and second verbal questions; and
providing the suggestion from the voice services node over the voiced call to the real estate seller.

5. The method of claim 1, wherein posting the listing data comprises providing the listing data on a web page.

6. The method of claim 1, wherein posting the listing data comprises providing verbal information based on the listing data from the voice services node over a voiced call to a real estate customer.

7. The method of claim 1, wherein the voiced call is a landline call.

8. The method of claim 1, wherein the voiced call is a wireless call.

9. The method of claim 1, further comprising accessing an external listing service database of real estate information based on the listing data produced from the verbal answers, wherein the listing data includes an identifier of the real estate.

10. A method of assisting real estate purchases with automation utilizing verbal communication, comprising:
receiving verbal information from a real estate customer at a voice services node;
interpreting the verbal information to produce a query for real estate listing data;
converting the real estate listing data resulting from the query into verbal real estate listing information; and
providing verbal real estate listing information from the voice services node to the real estate customer.

11. The method of claim 10, further comprising:
providing a verbal question about a real estate listing from the voice services node to the real estate customer;
receiving a verbal answer to the verbal question from the real estate customer at the voice services node,
interpreting the received verbal answer to generate an additional query to the real estate listing data; and
providing verbal real estate listing information based on the listing data from the voice services node to the real estate customer.

12. The method of claim 11, wherein providing a verbal question about a real estate listing occurs in response to receiving a verbal question from the real estate customer and is based upon the verbal question.

13. The method of claim 10, further comprising:
receiving a verbal question from the real estate customer at the voice services node;
interpreting the received verbal question to generate an additional query to the real estate listing data; and
providing verbal real estate listing information based on the listing data from the voice services node to the real estate customer.

14. The method of claim 12, wherein receiving the verbal question from the real estate customer occurs while verbal real estate listing information is being provided from the voice services node to the real estate customer.

15. The method of claim 10, further comprising receiving the listing data from a real estate seller through a web page and storing the listing data in preparation for receiving queries.

16. The method of claim 10, further comprising receiving the listing data by receiving verbal information at the voice services node over a voiced call from a real estate seller and storing the listing data in preparation for receiving queries such that the real estate customer may access the listing data immediately after receiving and storing the verbal information from the real estate seller.

17. The method of claim 10, wherein the voiced call is a landline call.

18. The method of claim 10, wherein the voiced call is a wireless call.

19. The method of claim 10, wherein the verbal information from the real estate customer identifies a piece of real estate and wherein the query for real estate listing data obtains data relative to the identified piece of real estate.

20. The method of claim 10, wherein the verbal information identifies preferences of the real estate customer, and wherein the query for real estate listing data obtains an identification of one or more pieces of real estate based on the preferences.

21. The method of claim 20, wherein providing verbal real estate information comprises providing verbal directions to the location of the one or more pieces of real estate.

22. The method of claim 10, wherein the verbal real estate listing information specifies a particular real estate listing including a real estate seller, the method further comprising interpreting the verbal information to initiate automated scheduling of an appointment between the real estate customer and the real estate seller.

23. The method of claim 10, further comprising:
determining a location of the real estate customer based on the real estate customer accessing a communications network, and wherein interpreting the verbal information to produce a query for real estate listing data further comprises including the location of the real estate customer in the query.

24. The method of claim 10, further comprising providing visual real estate listing information and directors to the real estate customer in addition to the verbal real estate listing information from the voice services node.

25. A system for assisting real estate sales with automation utilizing verbal communication, comprising:
a voice services node that provides verbal questions based on question data to a real estate seller, receives verbal answers from the real estate seller, and interprets the verbal answers to produce answer data;
a listing database containing listing data; and
a network-based computer implemented application that provides the question data to the voice services node, receives the answer data from the voice services node and stores the answer data as listing data in the database where it is accessible for real estate customers.

26. The system of claim 25, wherein the voice services node also receives verbal information from real estate customers, interprets the verbal information to produce query data, and provides verbal listing information to the real estate customer based on listing data, and wherein the network-based computer implemented application also receives the query data to produce a query of the listing data, and provides the listing data resulting from the query to the voice services node.

27. A system for assisting real estate purchases with automation utilizing verbal communication, comprising:
a voice services node that receives verbal information from a real estate customer, interprets the verbal information to produce query data, and provides verbal responses to the real estate customer based on listing data;
a listing database containing listing data; and
a network-based computer implemented application that receives query data from the voice services node to produce a query of listing data and that provides listing data resulting from the query to the voice services node.

28. The system of claim 27, wherein the voice services node also provides verbal questions based on question data to a real estate seller, receives verbal answers from the real estate seller, and interprets the verbal answers from the real estate seller to produce answer data, and wherein the network-based computer-implemented application provides the question data to the voice services node, receives the answer data, and stores the answer data as listing data in the listing database.
